(19) United States
(12) Patent Application Publication
(10) Pub. No.: US 2026/0170722 A1
(43) Pub. Date: Jun. 18, 2026

(54) CONTROLLABLE VIDEO AND IMAGE GENERATION WITH SLIDERS

(71) Applicant: ADOBE INC., SAN JOSE, CA (US)

(72) Inventors: Zixin Zhu, Buffalo, NY (US); Ratheesh Kalarot, Hayward, CA (US); Mamshad Nayeem Rizve, Cupertino, CA (US); Kevin Duarte, San Jose, CA (US); Chengyuan Xu, Sunnyvale, CA (US)

(21) Appl. No.: 18/981,742

(22) Filed: Dec. 16, 2024

(51) Int. Cl. G06T 11/60; G06T 3/4046; G06T 5/60; G06T 5/70

(52) U.S. Cl. CPC G06T 11/60; G06T 3/4046; G06T 5/60; G06T 5/70; G06T 2207/20081; G06T 2210/36

(57) ABSTRACT

A method, apparatus, non-transitory computer readable medium, and system for generating a synthetic image includes obtaining an attribute prompt that indicates a level of an attribute. An image generation prior model is configured to scale an attribute token based on the attribute prompt to obtain a scaled attribute token representing the level of the attribute and generate a condition embedding based on the scaled attribute token, wherein the condition embedding represent the level of the attribute. Subsequently, an image generation model generates a synthetic image based on the condition embedding, wherein the synthetic image depicts the attribute at the level of the attribute indicated by the attribute prompt.

### BACKGROUND

The following generally relates to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model may be trained to predict information in response to an input prompt, and to then generate an output based on the predicted information. In some cases, the prompt can be used to perform a complex manipulation and compositing. The generated output provides for a user to edit or generate an image with desired features and therefore makes image generation easier for a layperson and also more readily automated.

### SUMMARY

The present disclosure describes systems and methods for image processing, more specifically to image generation using an input text prompt. Embodiments of the present disclosure include an image processing apparatus configured to generate a synthetic image based on a user input that indicates a desired attribute. The image processing apparatus comprises an image generation prior model that generates a condition embedding based on the user input and the input text prompt. In some cases, the image generation prior model is trained based on a combination of losses to predict the condition embedding. Subsequently, a pre-trained diffusion model uses the condition embedding to generate the synthetic image that depicts a modified attribute of an image aligned with the user input.

A method, apparatus, and non-transitory computer readable medium for image processing are described. One or more aspects of the method, apparatus, and non-transitory computer readable medium include obtaining an attribute prompt that indicates a level of an attribute; scaling an attribute token based on the attribute prompt to obtain a scaled attribute token representing the level of the attribute; generating, using an image generation prior model, a condition embedding based on the scaled attribute token, wherein the condition embedding represent the level of the attribute; and generating, using an image generation model, a synthetic image based on the condition embedding, wherein the synthetic image depicts the attribute at the level of the attribute indicated by the attribute prompt.

A method, apparatus, and non-transitory computer readable medium for image processing are described. One or more aspects of the method, apparatus, and non-transitory computer readable medium include obtaining a training set including a source image and a scaled attribute token indicating a level of an attribute of the source image; generating a predicted condition embedding based on the scaled attribute token; and training, using the training set and the scaled attribute token, an image generation prior model to generate a synthetic image that depicts the attribute at the level of the attribute indicated by the scaled attribute to.

An apparatus and system for image processing are described. One or more aspects of the apparatus and system include a memory component; a processing device coupled to the memory component, the processing device configured to perform operations comprising obtaining an attribute prompt that indicates a level of an attribute; scaling an attribute token based on the attribute prompt to obtain a scaled attribute token representing the level of the attribute; generating, using an image generation prior model, a condition embedding based on the scaled attribute token, wherein the condition embedding represent the level of the attribute; and generating, using an image generation model, a synthetic image based on the condition embedding, wherein the synthetic image that depicts the attribute at the level indicated by the attribute prompt.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIGS. 3 through 4 show examples of a synthetic image generation process according to aspects of the present disclosure.

FIG. 5 shows an example of an image processing method according to aspects of the present disclosure.

FIG. 6 shows an example of a latent diffusion process according to aspects of the present disclosure.

FIG. 7 shows an example of a U-net architecture according to aspects of the present disclosure.

FIG. 8 shows an example of a denoising diffusion process according to aspects of the present disclosure.

FIG. 9 shows an example of a method for image processing according to aspects of the present disclosure.

FIG. 10 shows an example of a training method for the image generation prior model according to aspects of the present disclosure.

FIG. 11 shows an example of an image generation prior model training according to aspects of the present disclosure.

FIG. 12 shows an example of a method for computing a classification loss according to aspects of the present disclosure.

FIG. 13 shows an example of a method for training a machine learning model according to aspects of the present disclosure.

FIG. 14 shows an example of a method of training a diffusion model according to aspects of the present disclosure.

FIG. 15 shows an example of a computing device according to aspects of the present disclosure.

FIG. 16 shows an example of an image processing apparatus according to aspects of the present disclosure.

### DETAILED DESCRIPTION

The present disclosure describes systems and methods for image processing, more specifically to image generation using an input text prompt. Embodiments of the present disclosure include an image processing apparatus configured to generate a synthetic image based on a user input that indicates a desired attribute. The image processing apparatus comprises an image generation prior model that generates a condition embedding based on the user input and the input text prompt. In some cases, the image generation prior model is trained based on a combination of losses to predict the condition embedding. Subsequently, a pre-trained diffusion model uses the condition embedding to generate the synthetic image that depicts a modified attribute of an image aligned with the user input.

Existing systems use diffusion-based methods for generation of images. For example, existing image generation systems may generate images using a diffusion model and then implement a separate model for modifying the image attributes. Such systems result in increased inference time and high resource consumption. In some examples, the model for modifying the image attributes is able to perform fine-grained image editing but is computationally expensive with high inference costs due to inherent complexities.

Moreover, in some cases, existing image generation systems require re-training of the model for each attribute. As a result, the model is trained each time the user wants to modify a different or new attribute in the generated image which significantly enhances the computational costs. Therefore, there is a need in the art for an image processing system that can perform image generation with fine-grained attribute control while utilizing minimal computational resources.

Embodiments of the present disclosure include an image processing apparatus configured to generate a synthetic image that accurately aligns with each aspect of a user provided input. An embodiment of the present disclosure is configured to provide a slider-based user interface that provides for increased precision in modification of an attribute of an image to generate the synthetic image. In some cases, the image processing apparatus is configured to perform fine-grained modification of an attribute associated with the generated image based on a disentanglement of a plurality of attributes.

The present disclosure describes systems and methods for image processing, more specifically for image generation based on a user input. According to an exemplary embodiment, the image processing apparatus of the present disclosure includes an image generation prior model based on a diffusion model that takes an attribute vector and an identity vector as input and efficiently generates a condition vector (e.g., a guidance vector) based on a combination of the attribute vector and the identity vector. In some cases, an image generation network (e.g., a pre-trained diffusion network) is used to generate a synthetic image based on the condition vector.

According to an embodiment, the image generation prior model comprises a diffusion architecture that is configured to perform the disentanglement of the attribute vector and the identity vector. For example, the diffusion architecture is a disentangling network that is configured to perform the disentanglement. In some examples, the diffusion model takes the user provided prompt and attribute conditions as input and efficiently and effectively generates the condition vector by combining the attribute vector and the identity vector.

An embodiment of the present disclosure is configured to perform a training of the image generation prior model. In some cases, the image generation prior model is a multi-layer neural network that is trained using a combination of losses. For example, the image generation prior model is trained using the combination of losses computed based on a weighted average of a diffusion loss, an identity (i.e., mean squared error) loss, and a classification loss. In some examples, by training the image generation prior model on a combination of losses, embodiments of the present disclosure are able to ensure that the condition vectors with the same identity are consistent (i.e., for different attributes). Additionally, embodiments are able to identify the changed attribute and quantify the change in the attribute.

In some cases, the diffusion loss is computed based on a ground-truth condition vector generated based on a source image and a condition vector generated using the image generation prior model by combining the attribute vector and the identity vector. Additionally, in some cases, the attribute vector is modified to generate an additional condition vector. In some cases, the classification loss is measured based on a difference between the additional condition vector and the condition vector. In some cases, the identity loss is measured based on the additional condition vector. For example, the identity loss is used to ensure that the representation of the condition vector with the same identity is consistent regardless of changes in a level of the attribute.

Accordingly, by performing a disentanglement of a plurality of attributes, embodiments of the present disclosure are able to easily modify each attribute independently. Additionally, by enabling independent modification of the plurality of attributes, embodiments are able to prevent a retraining of the image generation model which results in significantly reduced inference time and computational resources.

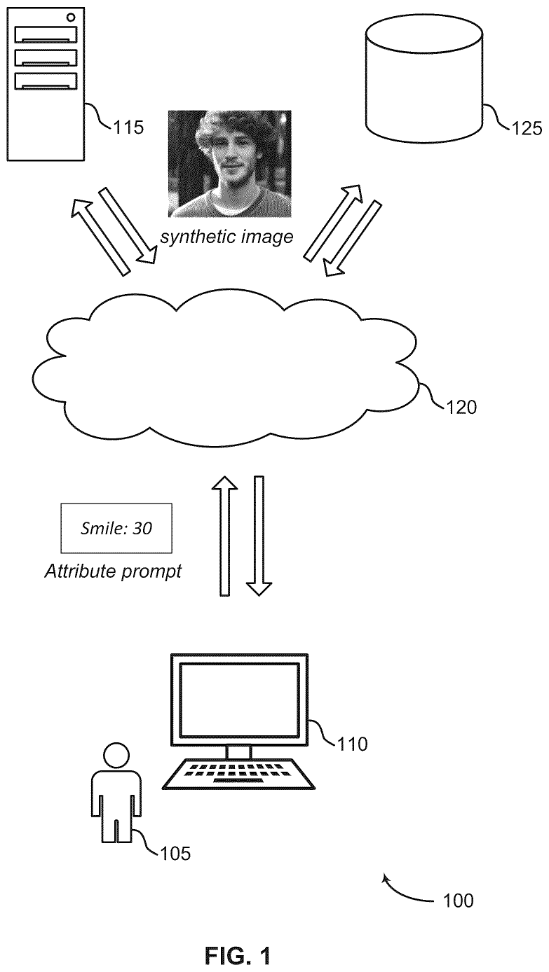

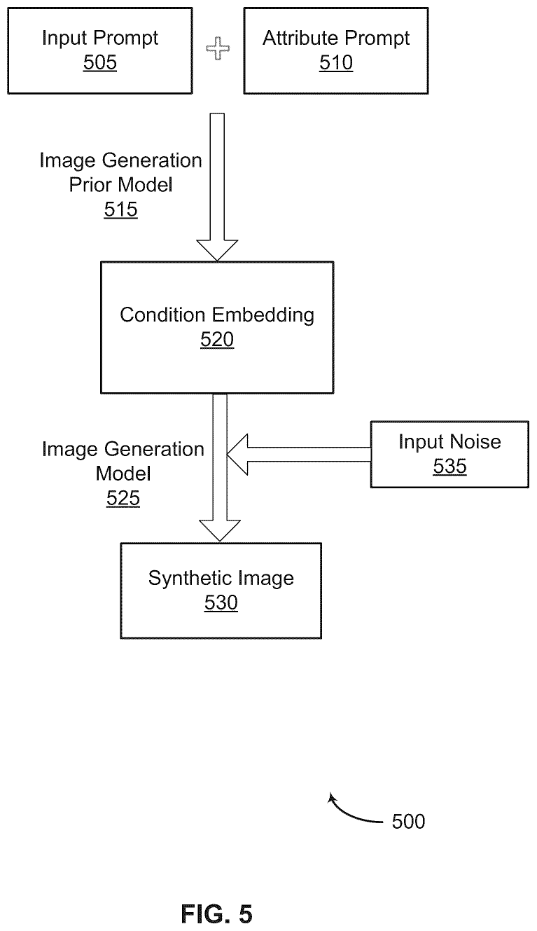

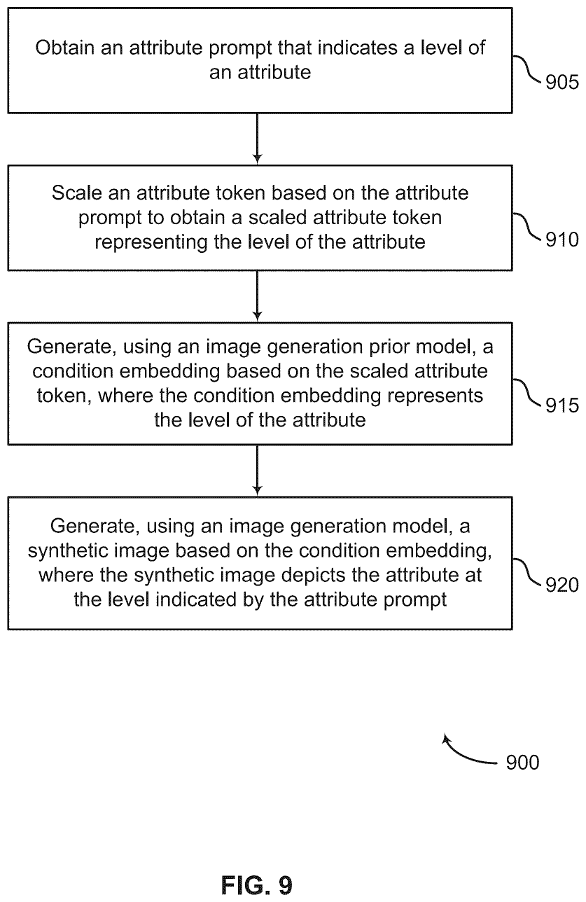

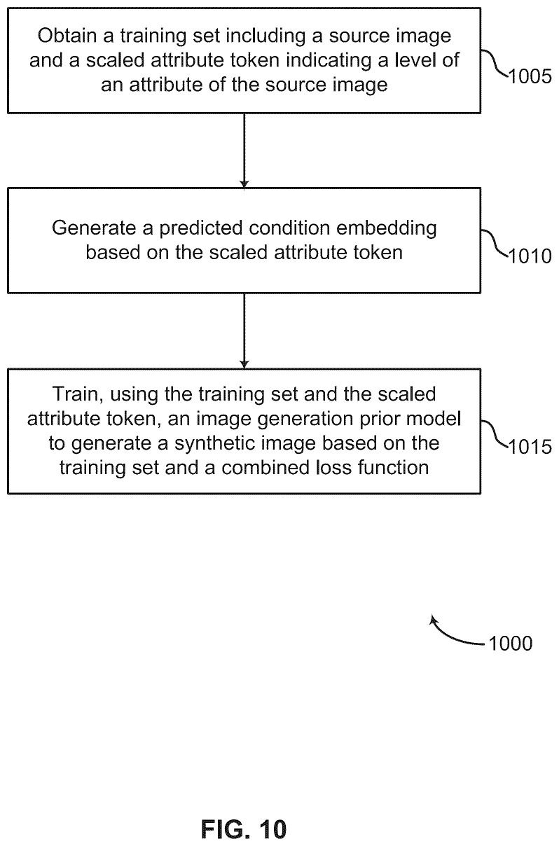

Embodiments of the present disclosure can be implemented in an image processing system. For example, the image processing system based on the present disclosure takes an attribute prompt (e.g., describing a level of an attribute) and generates an output that accurately depicts the attribute level described in the attribute prompt. Example applications regarding generating an output that depicts the desired level of attribute are provided with reference to FIGS. 1-4. Details regarding the architecture of the image generation prior model are provided with reference to FIGS. 5-8 and 15-16. Details regarding an operation of the image generation prior model are provided with reference to FIG. 9. Examples of a process for training the image generation prior model are provided with reference to FIGS. 10-14.

### Image Generation System

A system and an apparatus for image processing are described with reference to FIGS. 1-8. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides an attribute prompt to image processing apparatus 115 via a user interface provided on user device 110 by image processing apparatus 115. In some examples, the input attribute refers to a specific attribute such that the image processing apparatus provides user 105 with a high precision in manipulating the attribute to generate the synthetic image. In some examples, the attribute is input to image processing apparatus 115 via a user interface such as a slider that corresponds to a specific attribute. As shown in FIG. 1, the attribute indicates a scale that provides a level of the attribute (e.g., “Smile: 30”) based on which the user wants to generate a synthetic image using the image processing apparatus 115 of the present disclosure.

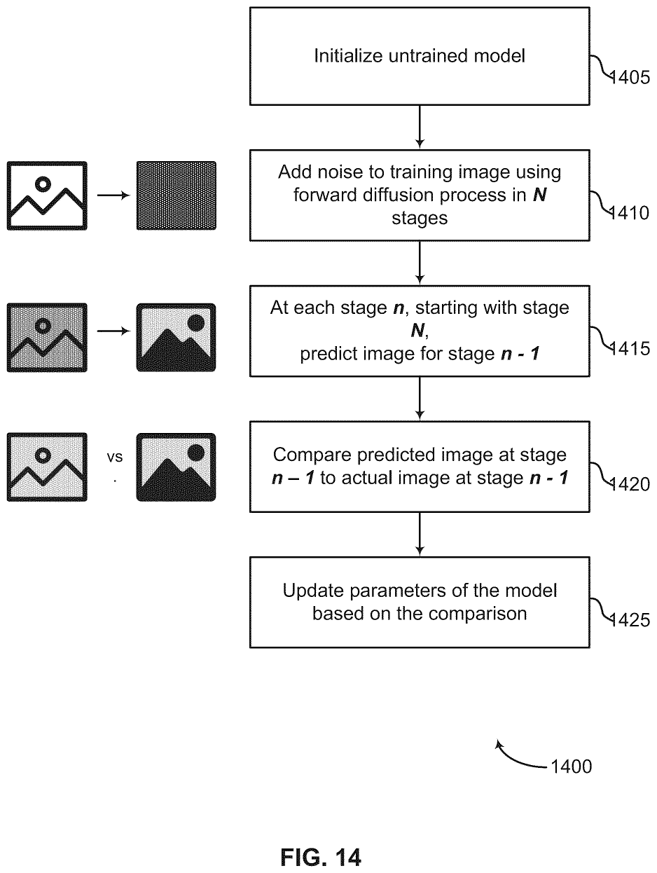

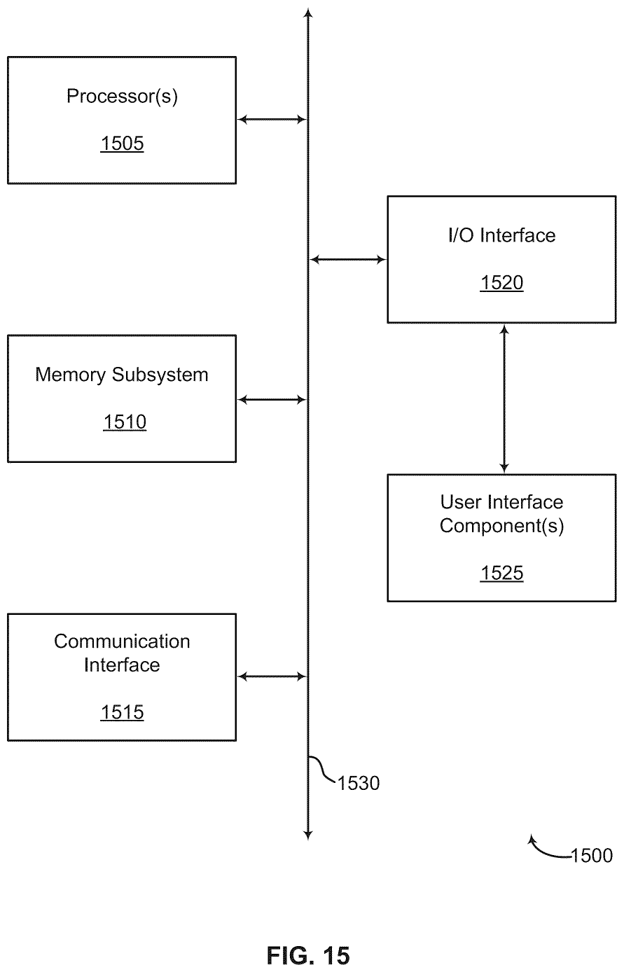

According to some aspects, the image processing apparatus 115 obtains an attribute (e.g., “Smile”) and a level of the attribute (e.g., “30”). In some examples, the attribute includes an emotion, age, skin tone for human related attributes. In some examples, the attribute includes a quantity and a style of objects for non-human related attributes. However, embodiments are not limited thereto. According to some aspects, the image processing apparatus 115 is configured to generate a synthetic video (e.g. instead of a synthetic image as shown in FIG. 1) that depicts a specific attribute indicated by a user prompt (e.g., based on fine-grained control over the attribute via a slider of the user interface, such as user interface described with reference to FIGS. 14-15).

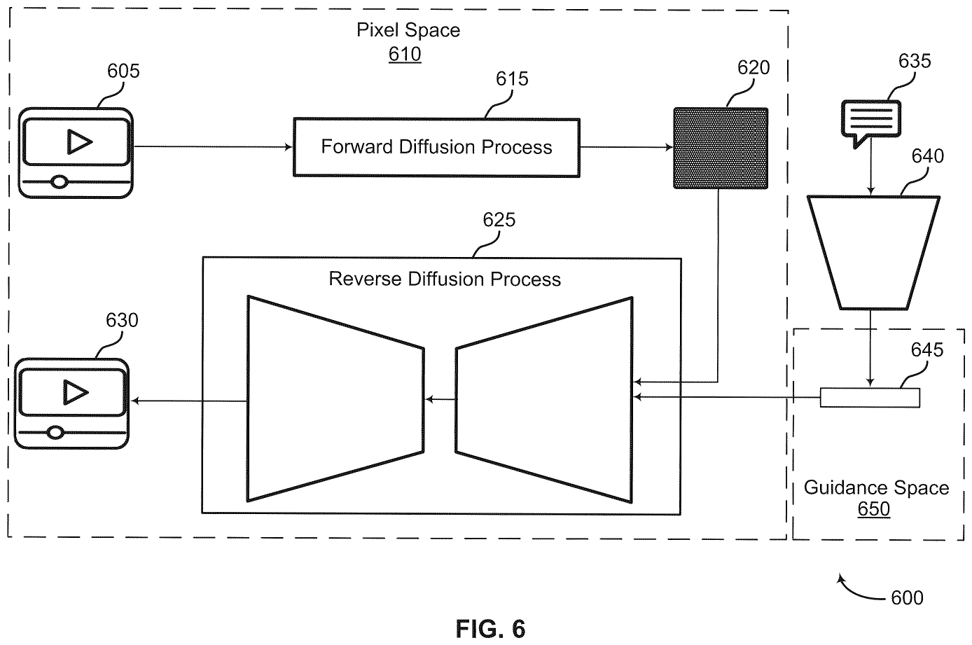

In some cases, the image processing apparatus 115 implements an image generation prior model (such as the image generation prior model described with reference to at least FIGS. 5-8 and 16) and an image generation model (such as the image generation model described with reference to at least FIGS. 6-8) to generate a synthetic image that is based on an input attribute. In some cases, as shown in FIG. 1, the user provides an attribute prompt (e.g., indicating a level of the attribute) to the image processing apparatus 115, aspects of which the user wants to depict in the synthetic image. In some examples, the image processing apparatus generates a synthetic image that accurately depicts the level of the attribute prompt.

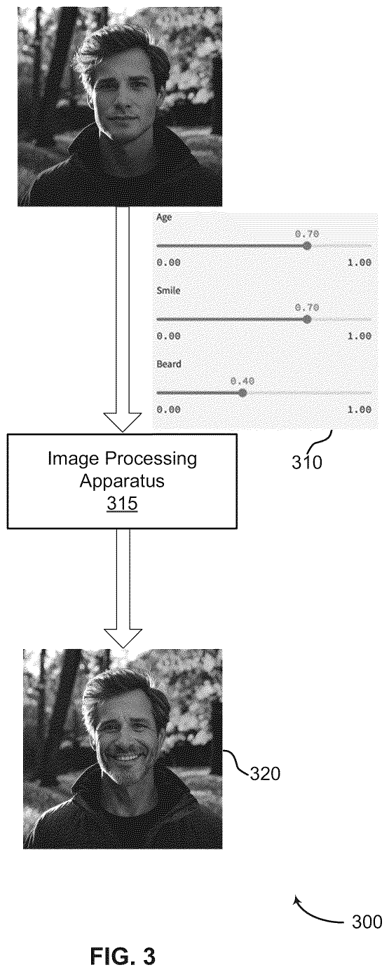

Referring again to the example of FIG. 1, the image processing apparatus 115 generates the synthetic image that accurately depicts each aspect (e.g., an attribute and a corresponding level of the attribute) described by the attribute prompt. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a video, etc.) to be communicated between user 105 and image processing apparatus 115. Image processing apparatus 115 is an example of, or includes aspects of, the corresponding element described with reference to FIGS. 3-4 and 16.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

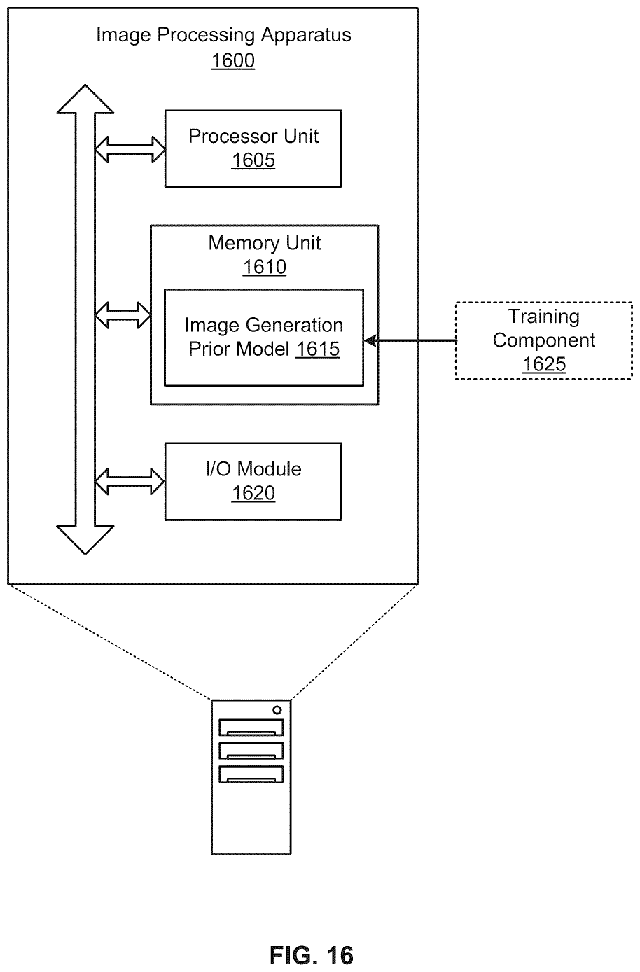

According to some aspects, image processing apparatus 115 includes a computer-implemented network. In some embodiments, the computer-implemented network includes a machine learning model (such as the image generation prior model described with reference to at least FIG. 16). In some embodiments, image processing apparatus 115 also includes one or more processors, a memory subsystem, a communication interface, an I/O interface, one or more user interface components, and a bus as described with reference to FIG. 14. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

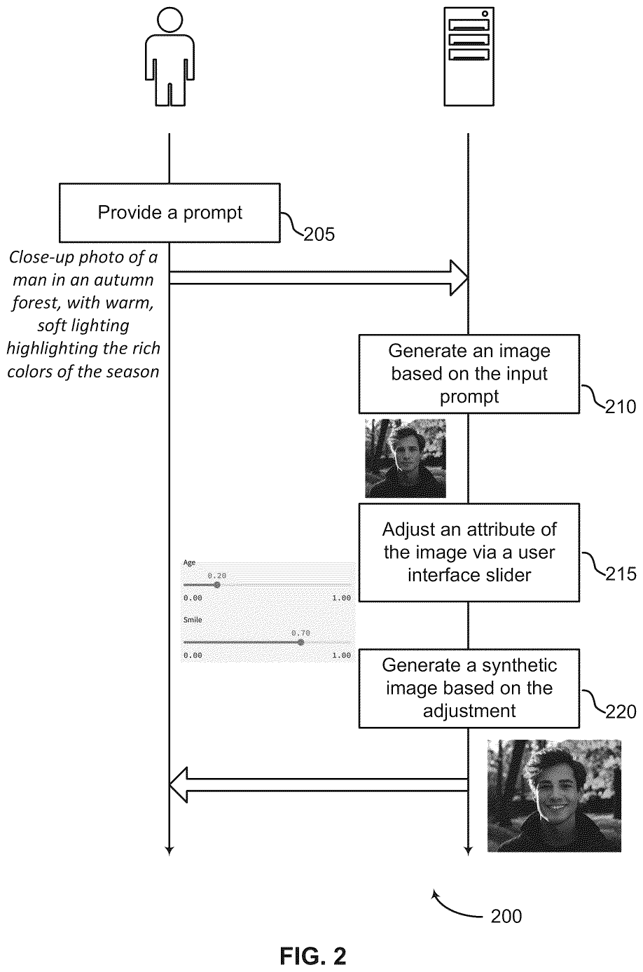

FIG. 2 shows an example of a method 200 for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, an image processing apparatus (such as the image processing apparatus described with reference to FIGS. 1, 3, and 16) provides a machine learning model (such as the image generation prior model described with reference to FIG. 16) that accurately generates a synthetic image depicting the level described in the input attribute prompt.

At operation 205, the system provides an input prompt. In some cases, the operations of this step refer to, or may be performed by, a user as described with reference to FIG. 1. For example, the user provides a prompt such as “Close-up photo of a man in an autumn forest, with warm, soft lighting highlighting the rich colors of the season” via the user interface described with reference to at least FIG. 1.

At operation 210, the system generates an image based on the input prompt. In some cases, the operations of this step refer to, or may be performed by, an image processing apparatus as described with reference to FIG. 16.

In some cases, the user provides a text prompt to the image processing apparatus (e.g., via a user interface as described in FIG. 1). For example, the text prompt provides an element based on which the user wants to generate an image, such as the man shown in FIGS. 1-3. In some examples, the image processing apparatus comprises a text-to-image model to generate the image at operation 210.

At operation 215, the user adjusts an attribute of the image via a user interface slider. In some cases, the operations of this step refer to, or may be performed by, an image processing apparatus as described with reference to FIGS. 1, 3-4, and 16.

In some cases, the user provides an attribute to the image processing apparatus. In some cases, the user provides the attribute via a user interface of the image processing apparatus. As shown in FIG. 2, the attribute is “age” and indicates a level “0.20” on a scale of “1.00” for the attribute based on which the user wants to generate an image. Additionally, as shown in FIG. 2, the attribute is a “smile” and indicates a level “0.70” on a scale of “1.00” for the attribute based on which the user wants to generate an image. For example, the user provides the attribute and the level of the attribute instructing the image processing apparatus to generate an image that corresponds to the attribute.

In some cases, the image processing apparatus includes an image generation prior model (such as image generation prior model described with reference to at least FIGS. 5 and 16) that is configured to generate a condition embedding based on the input text prompt (input text prompt obtained at operation 205) and the attribute prompt indicating a level of the attribute. In some examples, the image generation prior model is configured to explicitly disentangle the input attributes (e.g., disentangle different attributes) resulting in independent manipulation of a plurality of attributes.

At operation 220, the system generates a synthetic image based on the adjustment. In some cases, the operations of this step refer to, or may be performed by, an image processing apparatus as described with reference to FIG. 16.

Additionally, the image processing apparatus includes an image generation model (such as image generation model described with reference to at least FIGS. 5 and 16) that is configured to generate a synthetic image based on the condition embedding. For example, the synthetic image generated incorporates the attribute level (e.g., attribute level received at operation 215) into the image generated at operation 210. As shown in FIG. 2, the synthetic image depicts an age level of 0.20 and a smile level of 0.70 for the man in the image generated at operation 210. The synthetic image is provided to the user via a user interface of the user device.

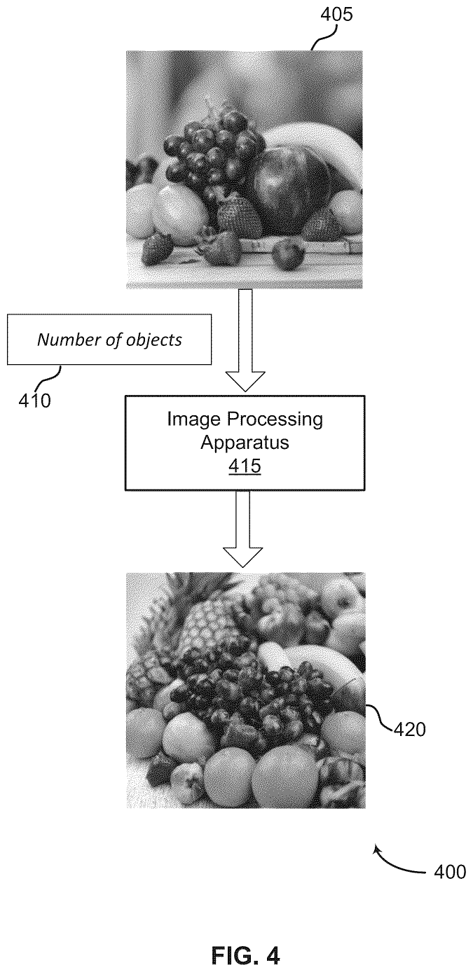

FIG. 3 shows an example of a synthetic image generation process 300 according to aspects of the present disclosure. Synthetic image generation process 300 is an example of, or includes aspects of, the corresponding element described with reference to FIG. 4. In one aspect, synthetic image generation process 300 includes input image 305, slider interface 310, image processing apparatus 315, and synthetic image 320. In some embodiments, a user indicates an attribute prompt that indicates a level of an attribute via the slider interface 310.

Referring to FIG. 3, input image 305 is a human image. Input image 305 depicts an element a user (such as the user described with reference to FIGS. 1-2) wants to modify. For example, the user wants to modify input image 305. In some examples, the user provides input image 305 to image processing apparatus 315 via a user interface of the image processing apparatus 315. Input image 305 is an example of, or includes aspects of, the corresponding element described with reference to FIGS. 1-2. In some examples, the user provides an input prompt to image processing apparatus 315 via a user interface of the image processing apparatus 315 based on which the image processing apparatus 315 generates an image (e.g., as shown in FIG. 2).

According to some aspects, the user wants to modify input image 305 based on an attribute provided via slider interface 310. In some examples, the user wants to modify input image 305 based on attributes such as age, smile, and beard as shown in FIG. 3. In some examples, the user provides a level of the attribute to image processing apparatus 315 via a slider interface 310 of the image processing apparatus 315. Slider interface 310 is an example of, or includes aspects of, the corresponding element described with reference to FIG. 2.

The image processing apparatus 315 (such as the image processing apparatus described with reference to FIGS. 1-2, 5, and 16) of the present disclosure receives input image 305 and an attribute (such as attributes 310) from the user. In some examples, image processing apparatus 315 comprises the image generation prior model that is configured to explicitly disentangle the input attributes (e.g., disentangle different attributes) resulting in independent manipulation of a plurality of attributes. Image processing apparatus 315 is an example of, or includes aspects of, the corresponding element described with reference to FIGS. 1-2, 4-5, and 16.

In some cases, the image processing apparatus generates synthetic image 320 that matches the attributes provided by slider interface 310. Thus, the image processing apparatus generates a synthetic image, such as a plurality of synthetic images 320 that are individually (e.g., independently) modified based on the plurality of attributes (e.g., age, smile, beard). Synthetic image 320 is an example of, or includes aspects of, the corresponding element described with reference to FIGS. 4 and 5. Further details regarding this operation are provided with reference to FIGS. 5 and 9-12.

FIG. 4 shows an example of a synthetic image generation process 400 according to aspects of the present disclosure. Synthetic image generation process 400 is an example of, or includes aspects of, the corresponding element described with reference to FIG. 3. In one aspect, synthetic image generation process 400 includes input image 405, attribute 410, image processing apparatus 415, and synthetic image 420.

Referring to FIG. 4, input image 405 is a non-human image. For example, the user (such as the user described with reference to FIGS. 1-2) wants to generate a synthetic image 420 with a different number of objects than input image 405. In some examples, the user provides input image 405 to image processing apparatus 415 via a user interface of the image processing apparatus 415. In some examples, the user provides attribute 410 to image processing apparatus 415 via a slider of the image processing apparatus 415. Input image 405 is an example of, or includes aspects of, the corresponding element described with reference to FIG. 3. Attribute 410 is an example of, or includes aspects of, the corresponding element described with reference to FIG. 3.

The image processing apparatus 415 (such as image processing apparatus described with reference to FIGS. 1-3 and 16) of the present disclosure receives the input image 405 from the user. Additionally, the image processing apparatus receives an attribute 410 (e.g., a level of the attribute such as a “number of objects”) from the user. In some cases, the image processing apparatus includes an image generation prior model that generates a condition embedding based on the input image 405 and attribute 410. Image processing apparatus 415 is an example of, or includes aspects of, the corresponding element described with reference to FIGS. 1 and 3.

In some cases, the image processing apparatus generates synthetic image 420 that matches the attributes provided by attribute 410. Thus, the image processing apparatus generates a synthetic image 420 that accurately depicts a different number of objects (as specified in attribute 410) than input image 405. Synthetic image 420 is an example of, or includes aspects of, the corresponding element described with reference to FIGS. 3 and 5. Further details regarding this operation are provided with reference to FIGS. 5 and 9-10.

FIG. 5 shows an example of an image processing method 500 according to aspects of the present disclosure. In one aspect, image processing method 500 includes input prompt 505, attribute prompt 510, image generation prior model 515, condition embedding 520, image generation model 525, synthetic image 530, and input noise 535.

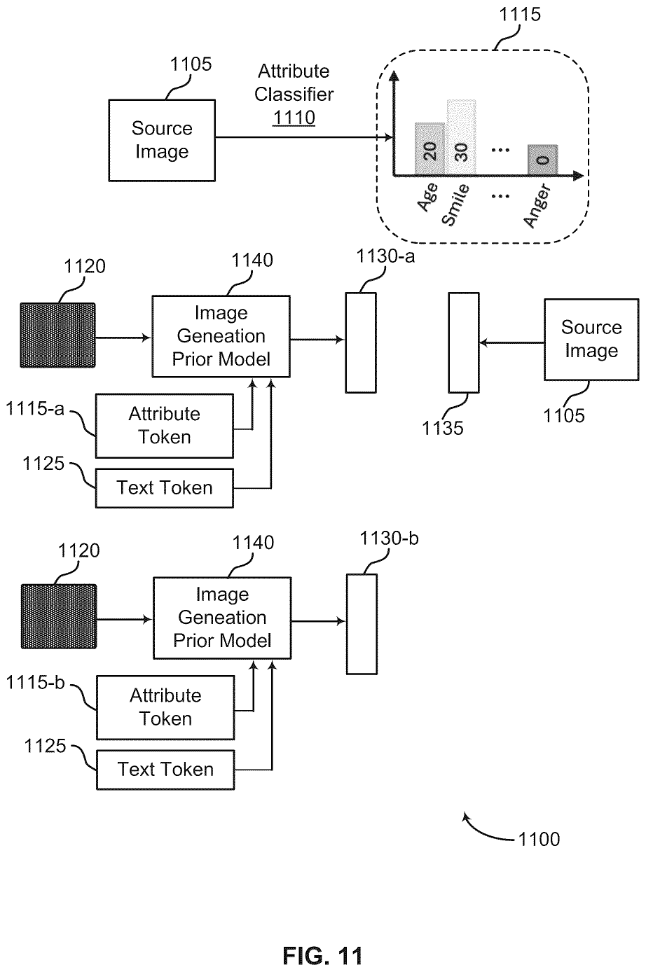

According to an embodiment of the present disclosure, the image processing apparatus is configured to determine a condition embedding. In some cases, the condition embedding 520 determines the attribute and identity of the synthetic image 530 (such as the synthetic image described with reference to FIGS. 1-4). In some cases, image generation prior model 515 is configured to receive input prompt 505 (such as input prompt described with reference to FIGS. 2-4) and attribute prompt (such as attribute prompt described with reference to FIGS. 1-4) and generate condition embedding 520. Condition embedding 520 is an example of, or includes aspects of, the corresponding element described with reference to FIG. 11.

In some cases, the image generation prior model 515 is based on a diffusion network (such as diffusion network described with reference to FIGS. 6-8) and is trained using a combined loss function (such as using training processes described with reference to FIGS. 10-12). In some cases, the condition embedding 520 is input to image generation model 525 to generate synthetic image 530 with a user-desired attribute (as provided in attribute prompt 510). Synthetic image 530 is an example of, or includes aspects of, the corresponding element described with reference to FIGS. 3 and 4.

In some cases, the image generation model 525 is based on a diffusion network (such as diffusion network described with reference to FIGS. 6-8). In some examples, image generation prior model 515 generates a guidance condition (such as condition embedding 520) for image generation model 525. For example, image generation prior model 515 is a disentangling network that is configured to separate the condition embedding 520 into a distinct attribute representation and an identity representation. In some examples, user (such as a user described with reference to FIGS. 1-4) combines the attribute representation and the identity representation to generate synthetic image 530 with the desired attributes and identity.

In some cases, image generation prior model 515 is implemented as a multi-layer neural network. Accordingly, by implementing the image generation prior model 515 as a multi-layer neural network that can explicitly disentangle a plurality of attributes for generation of a synthetic image (such as synthetic image 530) with desired attributes, embodiments of the present disclosure are able to perform the image generation process with significantly low training cost and low inference cost.

FIG. 6 shows an example of a guided diffusion model 600 according to aspects of the present disclosure. In some examples, guided diffusion model 600 describes the operation and architecture of the image generation model 1815 described with reference to FIG. 18. The guided latent diffusion model 600 depicted in FIG. 6 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 615 to gradually add noise to the original media item 605 to obtain noisy media item 620 at various noise levels.

Next, a reverse diffusion process 625 (e.g., a U-Net) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 7, 8, and 13-15.

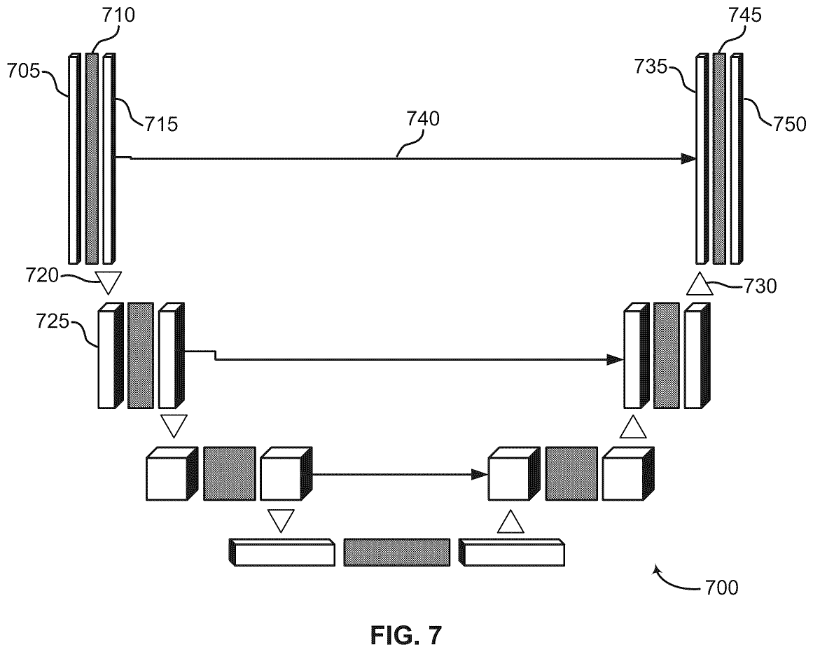

FIG. 7 shows an example of a U-Net 700 according to aspects of the present disclosure. In some examples, U-Net 700 is an example of the component that performs the reverse diffusion process 625 of guided diffusion model 600 described with reference to FIG. 6 and includes architectural elements of the image generation prior model 1615 described with reference to FIG. 16. The U-Net 700 depicted in FIG. 7 is an example of, or includes aspects of, the architecture used within the reverse diffusion process described with reference to FIG. 6.

In some examples, diffusion models are based on a neural network architecture known as a U-Net. The U-Net 700 takes input features 705 having an initial resolution and an initial number of channels and processes the input features 705 using an initial neural network layer 710 (e.g., a convolutional network layer) to produce intermediate features 715. The intermediate features 715 are then down-sampled using a down-sampling layer 720 such that down-sampled features 725 features have a resolution less than the initial resolution and a number of channels greater than the initial number of channels.

This process is repeated multiple times, and then the process is reversed. That is, the down-sampled features 725 are up-sampled using up-sampling process 730 to obtain up-sampled features 735. The up-sampled features 735 can be combined with intermediate features 715 having the same resolution and number of channels via a skip connection 740. These inputs are processed using a final neural network layer 745 to produce output features 750. In some cases, the output features 750 have the same resolution as the initial resolution and the same number of channels as the initial number of channels.

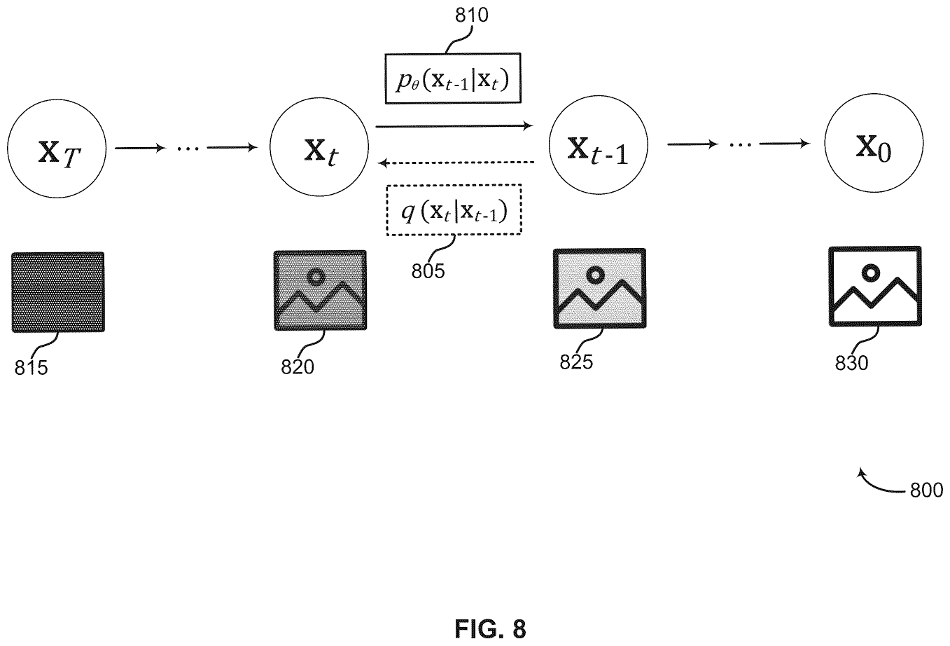

In some cases, U-Net 700 takes additional input features to produce conditionally generated output. For example, the additional input features could include a vector representation of an input prompt. The additional input features can be combined with the intermediate features 715 within the neural network at one or more layers. For example, a cross-attention module can be used to combine the additional input features and the intermediate features 715. U-Net architecture is an example of, or includes aspects of, the corresponding element described with reference to FIGS. 6 and 8.

FIG. 8 shows a diffusion process 800 according to aspects of the present disclosure. In some examples, diffusion process 800 describes an operation of the machine learning model (image generation prior model 1615) described with reference to FIG. 16, such as the reverse diffusion process 625 of guided diffusion model 600 described with reference to FIG. 6.

As described above with reference to FIG. 6, using a diffusion model can involve both a forward diffusion process 805 for adding noise to a media item (or features in a latent space) and a reverse diffusion process 810 for denoising the media item (or features) to obtain a denoised media item. The forward diffusion process 805 can be represented as q(xₜ|xₜ₋₁), and the reverse diffusion process 810 can be represented as p(xₜ₋₁|xₜ). In some cases, the forward diffusion process 805 is used during training to generate media items with successively greater noise, and a neural network is trained to perform the reverse diffusion process 810 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 810, the model begins with noisy data x_{T}, such as a noisy media item 815 and denoises the data to obtain the p (xₜ₋₁|xₜ). At each step t−1, the reverse diffusion process 810 takes xₜ, such as first intermediate media item 820, and t as input. Here, t represents a step in the sequence of transitions associated with different noise levels, The reverse diffusion process 810 outputs xₜ₋₁, such as second intermediate media item 825 iteratively until x_{T} reverts back to x₀, the original media item 830. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} \text{:} {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0,l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality. Diffusion process is an example of, or includes aspects of, the corresponding element described with reference to FIGS. 2, 5-7, and 13-16.

Accordingly, an apparatus for image processing is described. One or more aspects of the apparatus include a memory component; a processing device coupled to the memory component, the processing device configured to perform operations comprising: obtaining an attribute prompt that indicates a level of an attribute; scaling an attribute token based on the attribute prompt to obtain a scaled attribute token representing the level of the attribute; generating, using an image generation prior model, a condition embedding based on the scaled attribute token, wherein the condition embedding represent the level of the attribute; and generating, using an image generation model, a synthetic image based on the condition embedding, wherein the synthetic image depicts the attribute at the level indicated by the attribute prompt.

Some examples of the apparatus and system further include obtaining an input prompt describing an object, wherein the condition embedding is generated based on the input prompt and the synthetic image depicts the object with the attribute at the level indicated by the attribute prompt.

Some examples of the apparatus and system further include identifying a plurality of attribute tokens corresponding to a plurality of attributes, respectively; and. Some examples further include selecting an attribute token from the plurality of attribute tokens based on the attribute prompt.

Some examples of the apparatus and system further include obtaining an additional attribute prompt that indicates a level of an additional attribute. Some examples further include selecting an additional attribute token from a plurality of additional attribute tokens based on the attribute prompt. Some examples further include scaling the additional attribute token based on the additional attribute prompt to obtain an additional scaled attribute token representing the level of the additional attribute, wherein the condition embedding is based on the scaled attribute token and the additional scaled attribute token.

Some examples of the apparatus and system further include generating the condition embedding comprise obtaining a noisy embedding. Some examples further include denoising the noisy embedding based on the scaled attribute token. Some examples of the apparatus and system further include generating the synthetic image comprise obtaining a noise input. Some examples further include denoising the noise input based on the condition embedding. In some aspects, the image generation prior model is trained to generate the condition embedding representing the level of the attribute.

### Image Generation Process

The present disclosure describes systems and methods for image generation. Embodiments of the present disclosure are configured to perform text-to-image and/or text-to-video generation while achieving fine-grained control over a specific attribute in the generated (i.e., synthetic) image. For example, the image processing apparatus of the present disclosure is able to accurately generate a synthetic image that depicts a young or an old person based on an input attribute provided by the user via a slider of the user interface. In some examples, the slider is able to provide the user with an enhanced control over an attribute of the synthetic image.

According to an example, the slider corresponds to an attribute (e.g. a specific attribute) that provides high precision to the user in manipulating the synthetic image. In some examples, the image processing apparatus is able to modify an attribute, such as emotion, age, skin tone in human-based images and the quantity and style of objects in non-human based images. However, the attributes of an image that are modified by an image processing apparatus of the present disclosure are not limited thereto.

Embodiments of the present disclosure include the image processing apparatus configured to perform disentangling of a plurality of attributes. In some cases, the image processing apparatus is configured to perform synthetic image generation with the user desired attributes in a single forward pass. Accordingly, by explicitly disentangling attributes and providing for independent manipulation of the attributes, embodiments of the present disclosure are able to minimize resources (e.g., inference cost and model retraining) resulting in significantly fast and resource-efficient synthetic image generation process.

FIG. 9 shows an example of a method 900 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system obtains an attribute prompt that indicates a level of an attribute. In some cases, the operations of this step refer to, or may be performed by, a user interface as described with reference to FIGS. 1-2, and 15-16.

For example, in some cases, the user interface of the image processing apparatus (such as image processing apparatus 1600 described with reference to FIG. 16) receives an attribute prompt from a user (e.g., by providing a user interface with sliders corresponding to the attribute as shown in FIGS. 2 and 3). In some examples, the attribute prompt describes an attribute that the user wants to modify in the generated image (e.g., synthetic image). In some examples, the image processing apparatus receives the attribute prompt from a database or any other data source.

At operation 910, the system scales an attribute token based on the attribute prompt to obtain a scaled attribute token representing the level of the attribute. In some cases, the operations of this step refer to, or may be performed by, an image generation prior model as described with reference to FIGS. 5-8, 10-12, and 16.

According to an embodiment of the present disclosure, the image generation prior model is configured to classify an attribute of an image. In some examples, the image is obtained from a database. In some examples, the image is generated based on an input text prompt using a text-to-image model (such as a diffusion network). In some cases, the image is classified into a plurality of attributes, such as age, smile, emotion, skin tone, etc. However, embodiments are not limited thereto.

In some cases, the classified attribute (e.g., an attribute token) is provided to the image generation prior model. In some cases, the attribute token is used to determine the attribute, such as age, smile, emotion, skin tone, etc. In some cases, the attribute token refers to a continuous value that is projected to a vector embedding. In some examples, the attribute tokens are scaled based on a level of the attribute desired by the user. For example, “Smile: 30” is a scaled attribute token that indicates a level of smile desired by the user in the synthetic image (such as synthetic image described with reference to FIGS. 1-3).

At operation 915, the system generates a condition embedding based on the scaled attribute token, where the condition embedding represents the level of the attribute. In some cases, the operations of this step refer to, or may be performed by, an image generation prior model as described with reference to FIGS. 5-8, 10-12, and 16.

The image generation prior model is a disentangling network that is implemented as a multi-layer neural network. In some examples, the image generation prior model is a sequence of diffusion transformer blocks that are trained (e.g., trained using processes described with reference to at least FIGS. 10-12) to generate a condition embedding (such as condition embedding described with reference to FIG. 5). In some cases, the image generation prior model generates the condition embedding using an attribute prompt and a text prompt (such as attribute prompt described in FIGS. 1-5 and input prompt described in FIG. 5) as input.

At operation 920, the system generates a synthetic image based on the condition embedding, where the synthetic image depicts the attribute at the level indicated by the attribute prompt. In some cases, the operations of this step refer to, or may be performed by, an image generation model as described with reference to FIGS. 5-8, 14, and 16.

In some cases, the condition embedding is used by the image generation model (e.g., a pre-trained text-to-image model or a pre-trained text-to-video model such as a diffusion model described with reference to FIGS. 6-8) to generate a synthetic image. The synthetic image is generated via a diffusion process based on the condition embedding as described with reference to FIGS. 6-8 and 13-14. In some cases, the image generation model provides the synthetic image to the user via the user interface (such as the user interface described with reference to at least FIGS. 1-3).

Accordingly, a method for image processing is described. One or more aspects of the method include obtaining an attribute prompt that indicates a level of an attribute; scaling an attribute token based on the attribute prompt to obtain a scaled attribute token representing the level of the attribute; generating, using an image generation prior model, a condition embedding based on the scaled attribute token, wherein the condition embedding represent the level of the attribute; and generating, using an image generation model, a synthetic image based on the condition embedding, wherein the synthetic image depicts the attribute at the level indicated by the attribute prompt.

Some examples of the method, apparatus, and non-transitory computer readable medium further include obtaining an input prompt describing an object, wherein the condition embedding is generated based on the input prompt and the synthetic image depicts the object with the attribute at the level indicated by the attribute prompt.

Some examples of the method, apparatus, and non-transitory computer readable medium further include identifying a plurality of attribute tokens corresponding to a plurality of attributes, respectively. Some examples further include selecting an attribute token from the plurality of attribute tokens based on the attribute prompt.

Some examples of the method, apparatus, and non-transitory computer readable medium further include obtaining an additional attribute prompt that indicates a level of an additional attribute. Some examples further include selecting an additional attribute token from a plurality of additional attribute tokens based on the attribute prompt. Some examples further include scaling the additional attribute token based on the additional attribute prompt to obtain an additional scaled attribute token representing the level of the additional attribute, wherein the condition embedding is based on the scaled attribute token and the additional scaled attribute token.

Some examples of the method, apparatus, and non-transitory computer readable medium further include generating the condition embedding comprises obtaining a noisy embedding. Some examples further include denoising the noisy embedding based on the scaled attribute token.

Some examples of the method, apparatus, and non-transitory computer readable medium further include generating the synthetic image comprises obtaining a noise input. Some examples further include denoising the noise input based on the condition embedding. In some aspects, the image generation prior model is trained to generate the condition embedding representing the level of the attribute.

### Training

Embodiments of the present disclosure include an image processing apparatus configured to generate a synthetic image that accurately depicts a level of an attribute provided by the user using an attribute prompt. In some cases, the image processing apparatus includes an image generation prior model that is trained based on a combined loss function to generate a condition embedding using an input (e.g., text) prompt and the attribute prompt. In some cases, the combined loss function comprises a diffusion loss, a mean squared error loss, a classification loss or a combination thereof. In some cases, the image processing apparatus further includes an image generation model (e.g., a pre-trained diffusion network different from the image generation prior model) that generates a synthetic image based on the condition embedding.

According to an embodiment, the image processing apparatus includes a training component that is configured to receive an image (e.g., an image dataset or a video dataset) and extract an attribute token (e.g., a plurality of attribute tokens) associated with the image. Additionally or alternatively, the image processing apparatus comprises generation of a condition embedding for the image.

In some cases, the image processing apparatus comprises generation of a noise based on the image (e.g., using a diffusion process as described with reference to FIGS. 6-8). In some cases, the image generation prior model of the image processing apparatus takes the noise and the attribute token as input and generates a predicted condition embedding. In some cases, the image generation prior model is trained based on a comparison between the condition embedding and the predicted condition embedding. For example, the image generation prior model is trained by computing a combined loss function based on the condition embedding and the predicted condition embedding.

In some examples, the image generation prior model is trained to generate a denoised vector based on concatenating the attribute tokens in a sequence. The denoised vector is provided to the image generation model. In some cases, the denoised vector is used to guide a diffusion network of the image generation model to generate a synthetic image. For example, the synthetic image is able to accurately depict aspects of the attribute prompt (such as a scale of the user-provided attribute).

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains a training set including a source image and a scaled attribute token indicating a level of an attribute of the source image. In some cases, the operations of this step refer to, or may be performed by, a training component as described with reference to FIGS. 11-14 and 16.

In some cases, the training component obtains a training dataset including a source image. In some cases, a classifier (e.g., an attribute classifier) of the training component is used to extract attribute values from the source image. For example, the attribute values are scaled attribute values (e.g., continuous values) that are used by the image generation prior model as input. In some examples, the scaled attribute values (e.g., attribute token that indicates a level of an attribute) and a text embedding are provided as input to the image generation prior model. In some examples, the text embedding is obtained based on an input text prompt (such as input text prompt described with reference to FIGS. 2 and 5). In some examples, the text embedding is associated with the source image.

At operation 1010, the system generates a predicted condition embedding based on the scaled attribute token. In some cases, the operations of this step refer to, or may be performed by, an image generation prior model as described with reference to FIGS. 5-8, 9, 11-12, and 16.

According to an embodiment, the image generation prior model is configured to generate a predicted condition embedding based on a noise vector, the scaled attribute token, and the text embedding (e.g., based on concatenating the tokens in a sequence). In some cases, the noise vector is generated based on the source image. For example, the noise vector is generated based on adding noise to the source image using a diffusion network (such as the diffusion network described with reference to FIGS. 6-8).

In some cases, the image generation prior model is a multi-layer neural network and concatenates the text embedding and the attribute embedding in a sequence (e.g., the image generation prior model performs an attention process on the input) to generate a denoised vector, i.e., the predicted condition embedding.

At operation 1015, the system trains, using the training set and the scaled attribute token, an image generation prior model to generate a synthetic image based on the training set and a combined loss function. In some cases, the operations of this step refer to, or may be performed by, a training component as described with reference to FIGS. 11-14 and 16.

In some cases, the training component trains the image generation prior model based on the training set including the source image and the extracted attribute tokens as described in operation 1005. Additionally, the training component trains the image generation prior model based on the combined loss function, wherein the combined loss function is obtained by computing a weighted average of a diffusion loss, a classification loss, and a mean squared error loss.

In some cases, the diffusion loss is obtained based on the predicted condition embedding and a ground-truth condition embedding obtained based on the source image. Additionally, the training component computes a classification loss that ensures that the predicted condition embedding includes attribute information provided to the model. In some cases, the classification loss ensures disentangling of the attributes in the image generation prior model.

In some cases, an additional set of attribute tokens is computed by varying the scaled attribute values (such as the scaled attribute values obtained in operation 1005). In some cases, an additional set of attribute tokens are randomly selected. In some cases, the image generation prior model computes an additional predicted condition embedding based on the additional set of attribute tokens and the text tokens. The training component computes a mean squared error loss between the predicted condition embedding and the additional predicted condition embedding. In some cases, the mean squared error loss enables identity preservation of the source image.

Accordingly, by computing the classification loss and the mean squared error loss that ensure disentangling of different attributes in the image generation prior model, embodiments of the present disclosure are able to train multiple attributes simultaneously. Additionally, by training multiple attributes at the same time, embodiments are able to significantly save resources in terms of computation time and inference time.

FIG. 11 shows an example of an image generation prior model training according to aspects of the present disclosure. In one aspect, image generation prior model training process 1100 includes source image 1105, attribute classifier 1110, scaled attribute token 1115, noise vector 1120, text token 1125, predicted condition embedding 1130, and condition embedding 1135.

According to an embodiment of the present disclosure, the image generation prior model is trained using a combined loss function. In some cases, the combined loss function is computed based on a weighted average of a diffusion loss, a mean squared error loss, and a classification loss. In some cases, the image generation prior model is based on a diffusion network (such as a diffusion network described with reference to FIGS. 6-8) and trained as described herein.

In some cases, image generation prior model 1140 is conditioned based on an input text prompt and an attribute token extracted from source image 1105. For example, attribute classifier 1110 is used to extract an attribute from source image 1105 and generate scaled attribute token 1115. As shown with reference to FIG. 11, attribute classifier 1110 extracts attributes such as, but not limited to, age, smile, anger and scales them as 20, 30, 0, respectively based on source image 1105.

According to an embodiment, image generation prior model 1140 is configured to generate a predicted condition embedding 1130-a based on noise vector 1120, scaled attribute token 1115-a, and text token 1125. For example, predicted condition embedding 1130-a is generated based on concatenating the tokens in a sequence. In some cases, noise vector 1120 is generated based on the source image 1105. For example, noise vector 1120 is generated based on adding noise to the source image 1105 using a diffusion network (such as the diffusion network described with reference to FIGS. 6-8).

In some examples, the text embedding is embedded as a T5 text token. In some examples, the text token 1125 serves as an identity condition. In some examples, a T5 text encoder is used for embedding a text prompt. In some examples, a sine-cosine positional embedding is used for embedding the continuous attribute values. For example, scaled attribute token 1115 corresponds to scaled attribute token 1115-a.

According to an embodiment, training component (such as training component described with reference to FIGS. 10, 12, and 16) is configured to compute a diffusion loss:

$${ℒ}_{diff} = {E}_{{x}_{0} , ϵ ∼ ℕ ( 0 , 1 ) , t} [ {\vert ϵ - {ϵ}_{θ} ( {x}_{t} , t , c ) \vert}_{2}^{2} ] \qquad ( 3 )$$

where x₀ represents predicted condition embedding, xₜ is the noisy version of the data at timestep t, ϵ is the noise sampled from a Gaussian distribution, and c denotes the conditioning inputs, including the input text prompt (i.e., text token 1125) and attribute embedding (i.e., attribute token 1115-a).

In some cases, the diffusion loss computed by the training component is used to effectively train the image generation prior model 1140. For example, the diffusion loss is configured to train the image generation prior model ϵ_{θ} to predict noise ϵ at each timestep t. In some examples, the diffusion loss effectively denoises xₜ and guides the noisy version back to the original data distribution conditioned on the input.

According to an embodiment of the present disclosure, the training component computes a mean squared error loss. For example, the mean squared error loss is configured to ensure that the identity remains consistent for the same text prompt. In some examples, the mean squared error loss is configured to maintain consistent identity when different attributes are applied. That is, the mean squared error loss ensures that the predicted condition embedding 1130-a is consistent for the same identity as determined by text prompt (regardless of differing attributes).

In some cases, the training component is configured to randomly sample an additional set of attribute values. As shown with reference to FIG. 11, the training component extracts additional attributes such as, but not limited to, age, smile, anger and scales them as 60, 70, 30, respectively. The additional attributes (i.e., additional attribute tokens 1115-b different from attribute tokens 1115-a) are input to the image generation prior model 1140 to generate an additional predicted condition embedding 1130-b different from predicted condition embedding 1130-a.

In some cases, the training component computes the mean squared error loss as:

$${ℒ}_{ℳ𝒮ℰ} = {E}_{x , c , {c}^{′} , t , ϵ ∼ ℕ ( 0 , 1 )} [ {\vert {ϵ}_{θ} ( {x}_{t} , t , c ) - {ϵ}_{θ} ( {x}_{t} , t , {c}^{′} ) \vert}_{2}^{2} ] \qquad ( 4 )$$

where c and c′ represent different attribute sets (attribute token 1115-a and attribute token 1115-b) conditioned on the same text token. In some cases, the mean squared error loss ensures that the predicted noise ϵ_{θ}(xₜ, t, c) and ϵ_{θ}(xₜ, t, c′) are consistent. In some examples, the attribute values in the additional attribute token 1115-b are randomly sampled.

In some cases, the training component generates a mask based on the difference between the sampled values (additional attribute token 1115-b) and the original values (attribute token 1115-a). For example, the training component evaluates the said difference based on a threshold (e.g., threshold is set to 10%). In case the difference exceeds the threshold, the mask is applied to exclude the associated attributes from the mean squared error loss. Accordingly, by generating the mask, embodiments of the present disclosure are able to vary the generated condition embedding based on a variation of the attribute token.

According to an embodiment of the present disclosure, the training component is configured to compute a classification loss. In some cases, by incorporating the classification loss into the combined loss function to train the image generation prior model, embodiments of the present disclosure are able to disentangle different attributes and ensure smooth adjustments of the slider (such as the slider described with reference to FIGS. 1 and 3).

In some cases, the training component computes a classification loss that measures a difference between predicted noise ϵ_{θ}(xₜ, t, c) and ϵ_{θ}(xₜ, t, c′). In some cases, the classification loss identifies the changed attribute, such as attribute change in attribute token 1115-a (c) and additional attribute token 1115-b (c′). Additionally, the classification loss is configured to quantify the extent of the change in the attribute.

The training component computes classification loss as:

$${ℒ}_{clss} = \frac{1}{N} {\sum }_{i = 1}^{N} {ℒ}_{CE} ( f ( {ϵ}_{θ} ( {x}_{t} , t , c ) , {ϵ}_{θ} ( {x}_{t} , t , {c}^{′} ) ) , {y}_{i} ) \qquad ( 5 )$$

where [symbol] _{CE} denotes the cross-entropy loss, yᵢ denotes class label, and ƒ is the classifier function that predicts the class label based on the difference between the predicted condition embedding 1130-a and additional predicted condition embedding 1130-b, i.e., based on the difference between the predictions conditioned on attribute token 1115-a (c) and additional attribute token 1115-b (c′).

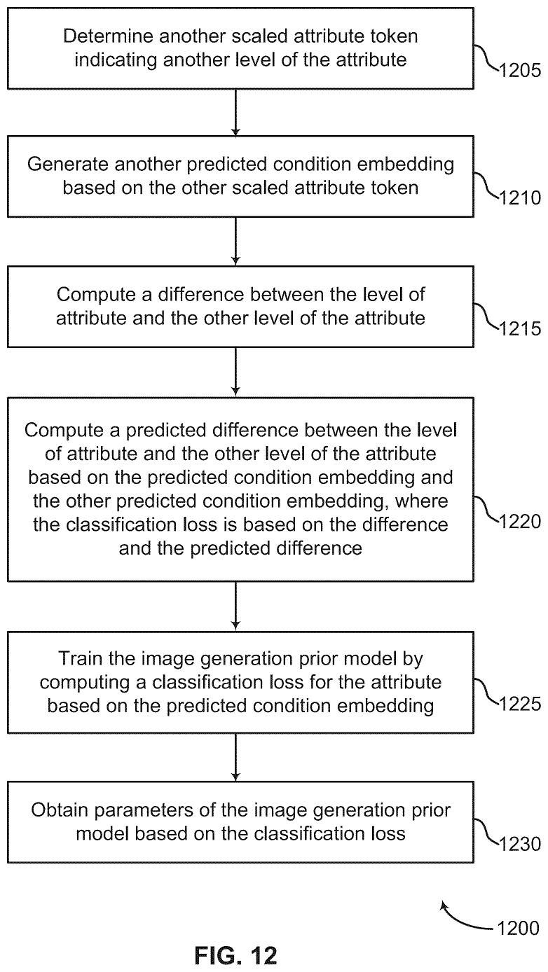

In some cases, the classification loss encourages the image generation prior model 1140 to accurately detect a magnitude of a change in the attribute (e.g., change in the attribute between attribute token 1115-a (c) and additional attribute token 1115-b (c′)). Additionally, the classification loss encourages the image generation prior model 1140 to accurately classify the magnitude of the change in the attribute. Accordingly, by computing the classification loss that accurately detects and classifies the magnitude of change in each attribute, embodiments of the present disclosure are able to ensure that the image generation prior model is consistent with the specified attribute variations. Further details regarding computation of the classification loss are provided with reference to FIG. 12.

The training component computes a combined loss function by computing a weighted average of the diffusion loss, the mean squared error loss, and the classification loss. The combined loss function is computed as:

$$ℒ = {w}_{d} {ℒ}_{diff} + {w}_{m} {ℒ}_{ℳ𝒮ℰ} + {w}_{C} {ℒ}_{clss} \qquad ( 6 )$$

where w_{d}, wₘ, and w_{C} represent the weights for the diffusion loss, MSE loss, and classification loss, respectively. In some examples, the weights for the diffusion loss, MSE loss, and classification loss are set to 1, 1, and 0.1, respectively.

Scaled attribute token 1115 is an example of, or includes aspects of, the corresponding element described with reference to FIGS. 5, 9-10, and 12. Predicted condition embedding 1130 is an example of, or includes aspects of, the corresponding element described with reference to FIGS. 10 and 12. Condition embedding 1135 is an example of, or includes aspects of, the corresponding element described with reference to FIGS. 5 and 9-10.

FIG. 12 shows an example of a method 1200 for computing a classification loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the system determines another scaled attribute token indicating another level of the attribute. In some cases, the operations of this step refer to, or may be performed by, a training component as described with reference to FIGS. 10-11 and 13-14.

According to an embodiment of the present disclosure, the training component is configured to sample (e.g., randomly sample) an additional attribute token c′ (e.g., additional attribute token 1115-b described with reference to FIG. 11). For example, the training component extracts additional attributes such as, but not limited to, age, smile, anger and scales them as 60, 70, 30, respectively.

At operation 1210, the system generates another predicted condition embedding based on the other scaled attribute token. In some cases, the operations of this step refer to, or may be performed by, an image generation prior model as described with reference to FIGS. 2, 5-9, 11 and 16. For example, referring again to FIG. 11, the additional attributes (i.e., additional attribute tokens 1115-b) are input to the image generation prior model 1140 to generate an additional predicted condition embedding 1130-b.

At operation 1215, the system computes a difference between the level of attribute and the other level of the attribute. In some cases, the operations of this step refer to, or may be performed by, a training component as described with reference to FIGS. 10-11 and 13-14.

At operation 1220, the system computes a predicted difference between the level of attribute and the other level of the attribute based on the predicted condition embedding and the other predicted condition embedding, where the classification loss is based on the difference and the predicted difference. In some cases, the operations of this step refer to, or may be performed by, a training component as described with reference to FIGS. 10-11 and 13-14.

According to an embodiment of the present disclosure, the training component is configured to compute the classification loss. In some cases, the classification loss is used to disentangle different attributes and ensure smooth adjustments while using the slider (such as the slider described with reference to FIGS. 1 and 3).

In some cases, the classification loss is used to measure a difference between the predicted condition embedding and the additional predicted condition embedding (such as predicted condition embedding 1130-a and additional predicted condition embedding 1130-b described with reference to FIG. 11). For example, the classification loss measures a difference between predicted noise ϵ_{θ}(xₜ, t, c) and ϵ_{θ}(xₜ, t, c′).

In some cases, the training component computes a difference between the attribute token c and the additional attribute token c′ for each attribute. For example, referring again to FIG. 11, the training component computes a difference between attribute token 1115-a and additional attribute tokens 1115-b. The training component computes the difference:

$$Δ c = {c}^{′} - c \qquad ( 7 )$$

The training component is configured to normalize the attribute values to the range [0,100] and the difference Δc to the range [0,200].

In some examples, the difference Δc is classified into 21 discrete classes, wherein each class represents a 10-unit interval. The class label yᵢ for the i-th attribute is given as:

$${y}_{i} = ⌊ \frac{Δ {c}_{i} + 100}{10} ⌋ + 21 \times ( i - 1 ) \qquad ( 8 )$$

where Δcᵢ represents the normalized difference for the i-th attribute, and 21×(i−1) ensures that each attribute occupies a corresponding range of 21 classes, resulting in a total of N×21 classes, where N is the total number of attributes.

At operation 1225, the system trains the image generation prior model including computing a classification loss for the attribute based on the predicted condition embedding. In some cases, the operations of this step refer to, or may be performed by, a training component as described with reference to FIGS. 10-11 and 13-14.

Further, the training component computes the classification loss as:

$${ℒ}_{clss} = \frac{1}{N} {\sum }_{i = 1}^{N} {ℒ}_{CE} ( f ( {ϵ}_{θ} ( {x}_{t} , t , c ) , {ϵ}_{θ} ( {x}_{t} , t , {c}^{′} ) ) , {y}_{i} ) \qquad ( 9 )$$

where [symbol] _{CE} denotes the cross-entropy loss, yᵢ denotes class label, and ƒ is the classifier function that predicts the class label based on the difference between the predicted condition embedding and additional predicted condition embedding, i.e., based on the difference between the predictions conditioned on attribute token (c) and additional attribute token (c′).

At operation 1230, the system obtains parameters of the image generation prior model based on the classification loss. In some cases, the operations of this step refer to, or may be performed by, a training component as described with reference to FIGS. 10-11 and 13-14.

In some cases, the classification loss encourages the image generation prior model (such as image generation prior model 1140 described with reference to FIG. 11) to accurately detect a magnitude of a change in the attribute (e.g., change in the attribute between attribute token and additional attribute token). Additionally, the classification loss encourages the image generation prior model to accurately classify the magnitude of the change in the attribute. Accordingly, by computing classification loss that accurately detects and classifies the magnitude of change in each attribute, embodiments of the present disclosure are able to ensure the image generation prior model is consistent with the specified attribute variations. Further details regarding computation of the classification loss are provided with reference to FIG. 11.

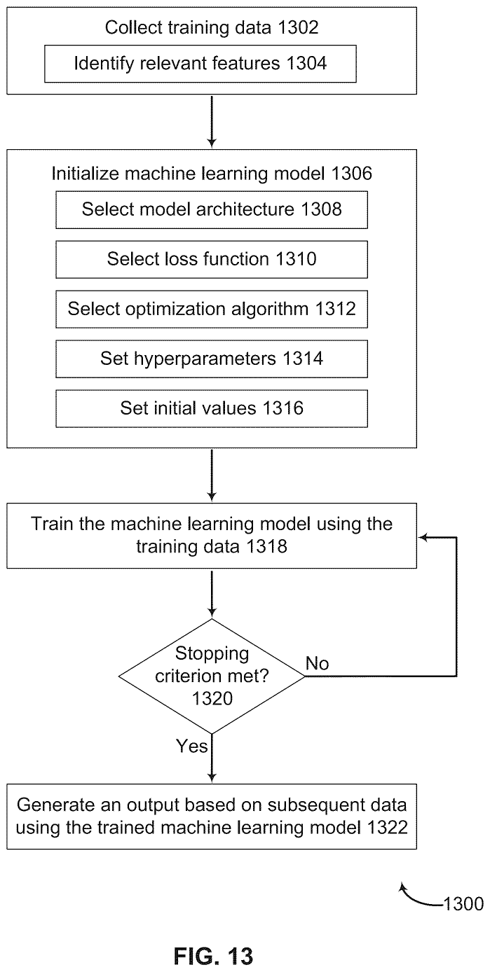

FIG. 13 shows an example of a method of training a machine learning model according to aspects of the present disclosure. FIG. 13 is a flow diagram depicting an algorithm as a step-by-step procedure 1300 in an example implementation of operations performable for training a machine-learning model. In some embodiments, the procedure 1300 describes an operation of the training component 1625 described for configuring the image generation prior model 1615 as described with reference to FIG. 16. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (1312) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore, once trained is configured to perform that task based on subsequent data received as an input and processed by the machine-learning model. The machine learning model is an example of, or includes aspects of, the intent model, language model, and image generation model described with reference to FIGS. 2, 6-8, 14, and 15.

FIG. 14 shows an example of a method of training a diffusion model 1400 according to aspects of the present disclosure. In some embodiments, the method 1400 describes an operation of the training component 1625 described for configuring the machine learning model (image generation prior model 1615) as described with reference to FIG. 16. The method 1400 represents an example for training a reverse diffusion process as described above with reference to FIGS. 6-8. In some examples, these operations are performed by a system including a processor executing a set of codes to control functional elements of an apparatus, such as the guided diffusion model described in FIG. 6.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 14, according to some aspects, a training component (such as the training component 1625 described with reference to FIG. 16) trains a diffusion model (such as the image generation prior model described with reference to FIGS. 5 and 16) to generate an output.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a training image (or an additional training image) using a forward diffusion process (such as the forward diffusion process described with reference to FIG. 6) in N stages. In some cases, the operations of this step refer to, or may be performed by, a training component as described with reference to FIG. 16.

At operation 1415, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1420, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1425, the system updates parameters of the model based on the comparison. For example, parameters of a U-Net may be updated using gradient descent. Time-dependent parameters of the Gaussian transitions can also be learned.

Accordingly, a method for image processing is described. One or more aspects of the method include obtaining a training set including a source image and a scaled attribute token indicating a level of an attribute of the source image; generating a predicted condition embedding based on the scaled attribute token; and training, using the training set and the scaled attribute token, an image generation prior model to generate a synthetic image based on the training set and a combined loss function.

Some examples of the method, apparatus, and non-transitory computer readable medium further include computing a diffusion loss based on the predicted condition embedding. Some examples further include obtaining parameters of the image generation prior model based on the diffusion loss. Some examples of the method, apparatus, and non-transitory computer readable medium further include generating a predicted image based on the predicted condition embedding. Some examples further include comparing the predicted image to the source image.

Some examples of the method, apparatus, and non-transitory computer readable medium further include computing a classification loss for the attribute based on the predicted condition embedding. Some examples further include obtaining parameters of the image generation prior model based on the classification loss. Some examples of the method, apparatus, and non-transitory computer readable medium further include determining another scaled attribute token indicating another level of the attribute. Some examples further include generating another predicted condition embedding based on the other scaled attribute token. Some examples further include computing a difference between the level of attribute and the other level of the attribute.

Some examples further include computing a predicted difference between the level of attribute and the other level of the attribute based on the predicted condition embedding and the other predicted condition embedding, wherein the classification loss is based on the difference and the predicted difference. Some examples of the method, apparatus, and non-transitory computer readable medium further include computing an identity loss for the attribute based on the predicted condition embedding. Some examples further include obtaining parameters of the image generation prior model based on the identity loss.

### Computing Device

FIG. 15 shows an example of a computing device according to aspects of the present disclosure. The computing device 1500 may be an example of the image processing apparatus 1600 described with reference to FIG. 16. In one aspect, computing device 1500 includes processor(s) 1505, memory subsystem 1510, communication interface 1515, I/O interface 1520, user interface component(s) 1525, and channel 1530.

In some embodiments, computing device 1500 is an example of, or includes aspects of, the image generation prior model of FIG. 16. In some embodiments, computing device 1500 includes one or more processors 1505 that can execute instructions stored in memory subsystem 1510 to perform media generation.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

FIG. 16 shows an example of an image processing apparatus 1600 according to aspects of the present disclosure. In one aspect, image processing apparatus 1600 includes processor unit 1605, memory unit 1610, image generation prior model 1615, I/O module 1620, and training component 1625.

In one aspect, image processing apparatus 1600 includes processor unit 1605, memory unit 1610, I/O module 1620, and training component 1625. Training component 1625 updates parameters of the machine learning model (image generation prior model 1615) stored in memory unit 1610. In some examples, the training component 1625 is located outside the image processing apparatus 1600.

According to some aspects, processor unit 1605 comprises a processing device coupled to the memory component. Processor unit 1605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1605 is configured to operate a memory array using a memory controller. In other cases, a memory controller is integrated into processor unit 1605. In some cases, processor unit 1605 is configured to execute computer-readable instructions stored in memory unit 1610 to perform various functions. In some aspects, processor unit 1605 includes special purpose components for modem processing, baseband processing, digital signal processing, or transmission processing. According to some aspects, processor unit 1605 comprises one or more processors described with reference to FIG. 15.

Memory unit 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1605 to perform various functions described herein.

In some cases, memory unit 1610 includes a basic input/output system (BIOS) that controls basic hardware or software operations, such as an interaction with peripheral components or devices. In some cases, memory unit 1610 includes a memory controller that operates memory cells of memory unit 1610. For example, the memory controller may include a row decoder, column decoder, or both. In some cases, memory cells within memory unit 1610 store information in the form of a logical state. According to some aspects, memory unit 1610 is an example of the memory subsystem 1510 described with reference to FIG. 15.

According to some aspects, image processing apparatus 1600 uses one or more processors of processor unit 1605 to execute instructions stored in memory unit 1610 to perform functions described herein. For example, the image processing apparatus 1600 may obtain an attribute prompt that indicates a level of an attribute; scale an attribute token based on the attribute prompt to obtain a scaled attribute token representing the level of the attribute; generate, using an image generation prior model, a condition embedding based on the scaled attribute token, wherein the condition embedding represent the level of the attribute; and generate, using an image generation model, a synthetic image based on the condition embedding, wherein the synthetic image depicts the attribute at the level indicated by the attribute prompt.

In one aspect, memory unit 1610 includes machine learning model (e.g., image generation prior model 1615 and image generation model) trained to obtain an attribute prompt that indicates a level of an attribute; scale an attribute token based on the attribute prompt to obtain a scaled attribute token representing the level of the attribute; generate, using an image generation prior model, a condition embedding based on the scaled attribute token, wherein the condition embedding represent the level of the attribute; and generate, using an image generation model, a synthetic image based on the condition embedding, wherein the synthetic image depicts the attribute at the level indicated by the attribute prompt.

For example, after training, the machine learning model (image generation prior model 1615 and image generation model) may perform inferencing operations as described with reference to FIGS. 1-4 to obtain an attribute prompt that indicates a level of an attribute; scale an attribute token based on the attribute prompt to obtain a scaled attribute token representing the level of the attribute; generate, using an image generation prior model, a condition embedding based on the scaled attribute token, wherein the condition embedding represent the level of the attribute; and generate, using an image generation model, a synthetic image based on the condition embedding, wherein the synthetic image depicts the attribute at the level indicated by the attribute prompt.

Machine learning model (e.g., image generation prior model 1615 and image generation model) is an example of, or includes aspects of, the corresponding element described with reference to FIGS. 3-4. In some embodiments, the machine learning model is an Artificial neural network (ANN) comprising a plurality of networks including the guided diffusion model described with reference to FIG. 6 and the U-Net described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model (e.g., image generation prior model 1615 and image generation model) can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

According to some aspects, image generation prior model 1615 scales an attribute token based on the attribute prompt to obtain a scaled attribute token representing the level of the attribute. In some examples, image generation prior model 1615 generates a condition embedding based on the scaled attribute token, where the condition embedding represent the level of the attribute. In some examples, image generation prior model 1615 identifies a set of attribute tokens corresponding to a set of attributes, respectively. In some examples, image generation prior model 1615 selects an attribute token from the set of attribute tokens based on the attribute prompt.

In some examples, image generation prior model 1615 selects an additional attribute token from a set of additional attribute tokens based on the attribute prompt. In some examples, image generation prior model 1615 scales the additional attribute token based on the additional attribute prompt to obtain an additional scaled attribute token representing the level of the additional attribute, where the condition embedding is based on the scaled attribute token and the additional scaled attribute token. In some examples, image generation prior model 1615 generates the condition embedding including obtaining a noisy embedding. In some examples, image generation prior model 1615 denoises the noisy embedding based on the scaled attribute token.

According to some aspects, image generation prior model 1615 generates a predicted condition embedding based on the scaled attribute token. In some examples, image generation prior model 1615 computes the classification loss including determining another scaled attribute token indicating another level of the attribute. In some examples, image generation prior model 1615 generates another predicted condition embedding based on the other scaled attribute token.

According to some aspects, image generation prior model 1615 comprise scaling an attribute token based on the attribute prompt to obtain a scaled attribute token representing the level of the attribute. In some examples, image generation prior model 1615 generates a condition embedding based on the scaled attribute token, wherein the condition embedding represent the level of the attribute. In some examples, image generation prior model 1615 identifies a set of attribute tokens corresponding to a set of attributes, respectively. In some examples, image generation prior model 1615 selects an attribute token from the set of attribute tokens based on the attribute prompt.

In some examples, image generation prior model 1615 selects an additional attribute token from a set of additional attribute tokens based on the attribute prompt. In some examples, image generation prior model 1615 comprises scaling the additional attribute token based on the additional attribute prompt to obtain an additional scaled attribute token representing the level of the additional attribute, where the condition embedding is based on the scaled attribute token and the additional scaled attribute token. In some examples, image generation prior model 1615 comprises generating the condition embedding including obtaining a noisy embedding. In some examples, image generation prior model 1615 comprises denoising the noisy embedding based on the scaled attribute token. In some aspects, the image generation prior model 1615 is trained to generate the condition embedding representing the level of the attribute.

According to some aspects, image generation model (such as image generation model described with reference to at least FIG. 5) generates a synthetic image based on the condition embedding, wherein the synthetic image depicts the attribute at the level indicated by the attribute prompt. In some examples, image generation model obtains a noise input. In some examples, image generation model comprises denoising the noise input based on the condition embedding.

According to some aspects, training component 1625 trains, using the training set and the scaled attribute token, an image generation prior model 1615 to generate a synthetic image based on the training set and a combined loss function. In some examples, training component 1625 trains the image generation prior model 1615 including computing a diffusion loss based on the predicted condition embedding. In some examples, training component 1625 obtains parameters of the image generation prior model 1615 based on the diffusion loss. In some examples, training component 1625 computes the diffusion loss including generating a predicted image based on the predicted condition embedding. In some examples, training component 1625 compares the predicted image to the source image.

In some examples, training component 1625 trains the image generation prior model 1615 including computing a classification loss for the attribute based on the predicted condition embedding. In some examples, training component 1625 obtains parameters of the image generation prior model 1615 based on the classification loss. In some examples, training component 1625 computes a difference between the level of attribute and the other level of the attribute. In some examples, training component 1625 computes a predicted difference between the level of attribute and the other level of the attribute based on the predicted condition embedding and the other predicted condition embedding, where the classification loss is based on the difference and the predicted difference.

In some examples, training component 1625 trains the image generation prior model 1615 including computing an identity loss for the attribute based on the predicted condition embedding. In some examples, training component 1625 obtains parameters of the image generation prior model 1615 based on the identity loss. In some aspects, the image generation prior model 1615 is trained to generate the condition embedding representing the level of the attribute.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an attribute prompt that indicates a level of an attribute;
scaling an attribute token based on the attribute prompt to obtain a scaled attribute token representing the level of the attribute;
generating, using an image generation prior model, a condition embedding based on the scaled attribute token, wherein the condition embedding represent the level of the attribute; and
generating, using an image generation model, a synthetic image based on the condition embedding, wherein the synthetic image depicts the attribute at the level of the attribute indicated by the attribute prompt.

2. The method of claim 1, further comprising:
obtaining an input prompt describing an object, wherein the condition embedding is generated based on the input prompt and the synthetic image depicts the object with the attribute at the level indicated by the attribute prompt.

3. The method of claim 1, further comprising:
identifying a plurality of attribute tokens corresponding to a plurality of attributes, respectively; and
selecting an attribute token from the plurality of attribute tokens based on the attribute prompt.

4. The method of claim 3, further comprising:
obtaining an additional attribute prompt that indicates a level of an additional attribute;
selecting an additional attribute token from a plurality of additional attribute tokens based on the attribute prompt; and
scaling the additional attribute token based on the additional attribute prompt to obtain an additional scaled attribute token representing the level of the additional attribute, wherein the condition embedding is based on the scaled attribute token and the additional scaled attribute token.

5. The method of claim 1, wherein generating the condition embedding comprises:
obtaining a noisy embedding; and
denoising the noisy embedding based on the scaled attribute token.

6. The method of claim 1, wherein generating the synthetic image comprises:
obtaining a noise input; and
denoising the noise input based on the condition embedding.

7. The method of claim 1, wherein:
the image generation prior model is trained to generate the condition embedding representing the level of the attribute.

8. A method of training a machine learning model, the method comprising:
obtaining a training set including a source image and a scaled attribute token indicating a level of an attribute of the source image;
generating a predicted condition embedding based on the scaled attribute token; and
training, using the training set and the predicted condition embedding, an image generation prior model to generate a synthetic image that depicts the attribute at the level of the attribute indicated by the scaled attribute token.

9. The method of claim 8, wherein training the image generation prior model comprises:
computing a diffusion loss based on the predicted condition embedding; and
updating parameters of the image generation prior model based on the diffusion loss.

10. The method of claim 9, wherein computing the diffusion loss comprises:
generating a predicted image based on the predicted condition embedding; and
comparing the predicted image to the source image.

11. The method of claim 8, wherein training the image generation prior model comprises:
computing a classification loss for the attribute based on the predicted condition embedding; and
updating parameters of the image generation prior model based on the classification loss.

12. The method of claim 11, wherein computing the classification loss comprises:
determining another scaled attribute token indicating another level of the attribute;
generating another predicted condition embedding based on the other scaled attribute token;
computing a difference between the level of attribute and the other level of the attribute; and
computing a predicted difference between the level of attribute and the other level of the attribute based on the predicted condition embedding and the other predicted condition embedding, wherein the classification loss is based on the difference and the predicted difference.

13. The method of claim 8, wherein training the image generation prior model comprises:
computing an identity loss for the attribute based on the predicted condition embedding; and
updating parameters of the image generation prior model based on the identity loss.

14. A system comprising:
a memory component; and
a processing device coupled to the memory component, the processing device configured to perform operations comprising:
obtaining an attribute prompt that indicates a level of an attribute;
scaling an attribute token based on the attribute prompt to obtain a scaled attribute token representing the level of the attribute;
generating, using an image generation prior model, a condition embedding based on the scaled attribute token, wherein the condition embedding represent the level of the attribute; and
generating, using an image generation model, a synthetic image based on the condition embedding, wherein the synthetic image depicts the attribute at the level of the attribute indicated by the attribute prompt.

15. The system of claim 14, wherein the processing device is further configured to perform operations comprising:
obtaining an input prompt describing an object, wherein the condition embedding is generated based on the input prompt and the synthetic image depicts the object with the attribute at the level indicated by the attribute prompt.

16. The system of claim 14, wherein the processing device is further configured to perform operations comprising:
identifying a plurality of attribute tokens corresponding to a plurality of attributes, respectively; and
selecting an attribute token from the plurality of attribute tokens based on the attribute prompt.

17. The system of claim 16, wherein the processing device is further configured to perform operations comprising:
obtaining an additional attribute prompt that indicates a level of an additional attribute;
selecting an additional attribute token from a plurality of additional attribute tokens based on the attribute prompt; and
scaling the additional attribute token based on the additional attribute prompt to obtain an additional scaled attribute token representing the level of the additional attribute, wherein the condition embedding is based on the scaled attribute token and the additional scaled attribute token.

18. The system of claim 14, wherein generating the condition embedding comprises:
obtaining a noisy embedding; and
denoising the noisy embedding based on the scaled attribute token.

19. The system of claim 14, wherein generating the synthetic image comprises:
obtaining a noise input; and
denoising the noise input based on the condition embedding.

20. The system of claim 14, wherein:
the image generation prior model is trained to generate the condition embedding representing the level of the attribute.
